(19) United States
(12) Patent Application Publication
(10) Pub. No.: US 2023/0029276 A1
(43) Pub. Date: Jan. 26, 2023

(54) PERSONAL SAMPLING FOR CLEAN ROOM APPLICATIONS

(71) Applicant: 3TC Robotics, LLC, York, PA (US)

(72) Inventors: John Mcelligott, York, PA (US); Colton Bailey, Denver, CO (US); Adam Rest, Wexford, PA (US); Jita Mondal, Red Lion, PA (US); Aishwarya Panchpor, York, PA (US)

(21) Appl. No.: 17/813,958

(22) Filed: Jul. 21, 2022

Related U.S. Application Data
(60) Provisional application No. 63/224,055, filed on Jul. 21, 2021.

(51) Int. Cl. G01N 35/00; B25J 21/00

(52) U.S. Cl. CPC G01N 35/0099; B25J 21/005; G01N 2035/00831; G01N 2035/0091

(57) ABSTRACT

An interactive living entity automatic sampling system includes a structure supporting components including a first sensor, a second sensor, a robotic arm, a camera, and a touchless interface, wherein the structure and the components are adapted for use in a clean room. The first sensor is adapted to sense the interactive living entity in response to the interactive living entity being at a predetermined position relative to the structure for a predetermined time. The second sensor is adapted to sense an indicia associated with the interactive living entity. In response to the second sensor sensing the indicia, the sampling system initiates an operating cycle, or continues the previously initiated operating cycle, for collecting a sample from the interactive living entity. During the operating cycle, the touchless interface provides positioning instructions to the interactive living entity in combination with the robotic arm handling a partially enclosed container for collecting the sample from the interactive living entity.

### RELATED APPLICATION

This application claims the benefit under 35 U.S.C. § 119(e) to U.S. Provisional Application Ser. No. 63/224,055 filed Jul. 21, 2021, the entirety of which is incorporated herein by reference.

### FIELD OF DISCLOSURE

The present disclosure is directed to personnel sampling systems for clean room applications.

### BACKGROUND

Currently, products and services produced within clean rooms requires personnel monitoring samples to be taken from sterile technicians involved in clean room applications. All sterile personnel must then wait in the clean room for additional outside personnel to take these samples before they can enter or exit the clean room. This is done multiple times throughout the day for shift changes, lunch breaks and even bathroom breaks. This results in a cumbersome and often time-consuming process. Waiting for additional outside personnel to arrive can also create the potential for contamination. In addition, the use of humans in this application leads to time loss, potential inaccuracy of samples and/or an increase in additional labor costs.

There is a need for clean room applications that do not suffer from the afore-mentioned shortcomings.

### SUMMARY

In some implementations, an interactive living entity sampling system includes a structure supporting components including a first sensor, a second sensor, a robotic arm, a camera, and a touchless interface, wherein the structure and the components are adapted for use in a clean room. The first sensor is adapted to sense the interactive living entity in response to the interactive living entity being at a predetermined position relative to the structure for a predetermined time. The second sensor is adapted to sense an indicia associated with the interactive living entity. In response to the second sensor sensing the indicia, the sampling system initiates an operating cycle, or continues the previously initiated operating cycle, for collecting a sample from the interactive living entity. During the operating cycle, the touchless interface provides positioning instructions to the interactive living entity in combination with the robotic arm handling a partially enclosed container for collecting the sample from the interactive living entity.

In some implementations, an automatic personnel sampling system, comprising a structure having a top portion and a bottom portion is disclosed. The top portion includes a first sensor configured to sense a presence of an interactive living entity, a second sensor configured to sense an indicia associated with the interactive living entity, a touchless interface configured to position the interactive living entity for collecting a sample from the interactive living entity, and a robot arm configured to handle an at least partially enclosed container that holds a growth medium adapted for cell culturing. The robot arm, in conjunction with the touchless interface, collects the sample from the interactive living entity by moving the partially enclosed container across each fingertip of a hand of the interactive living entity.

In some implementations, a method for automatically collecting a sample from an interactive living entity in a clean room is disclosed. The method includes providing a structure supporting components including a first sensor, a second sensor, a robotic arm, a camera, and a touchless interface, determining a presence of the interactive living entity when the interactive living entity is at a predetermined position relative to the structure for a predetermined time, determining an indicia associated with the interactive living entity, based on the determined presence of the interactive living entity and the determined indicia, initiating an operating cycle, or continuation of the previously initiated operating cycle, for collecting a sample from the interactive living entity, positioning the interactive living entity during the operating cycle; and handling a partially enclosed container, via the robotic arm, for collecting the sample in the partially enclosed container from the interactive living entity

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of a sampling system, according to an example embodiment of the present disclosure.

FIG. 2 is a front view of the sampling system of FIG. 1.

FIG. 3 is a side view of the sampling system of FIG. 1.

FIG. 4 is a side view opposite the side view of FIG. 3 of the sampling system of FIG. 1.

FIG. 5 is a schematic representation of a controller of the sampling system, according to an example embodiment of the present disclosure.

FIG. 6 is a flowchart of a method for automatically collecting a sample from an interactive living entity in a clean room, in accordance with an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Sampling systems of the present disclosure, such as integrated stand-alone collaborative robotic systems usable in clean rooms, provide a more reliable, automated, touchless human machine interface, sampling system that utilizes computer vision, Artificial Intelligence, collaborative robotic technology in conjunction with rapid and non-rapid growth agar plates or growth medium containers that directly interacts with the human body. Additionally, the present sampling systems reduce the chances of contamination, time loss, and result in reduced labor costs compared to manual manipulation of growth medium containers to collect samples from clean room personnel entering or exiting the clean room, in which the growth medium containers are then manually locked onto lids such as transparent lids, assigned operator identification, packaged and sent for analysis.

Further, the present sampling systems include the features of touchless hand pose human machine interface, automated lid and agar dish/plate handling, collaborative robotic sampling of personnel, automatic sample attribution, and/or database reporting. As a result, this eliminates the need for human-to-human contact, saves time and labor costs, reduces personnel downtime, inconsistent sampling as well as overall process related inefficiencies.

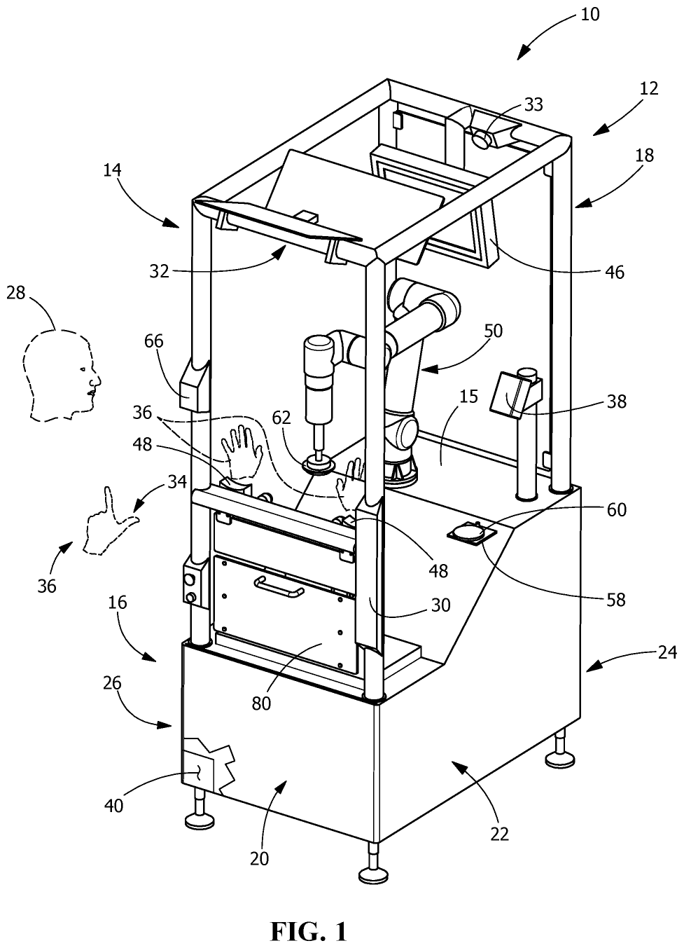

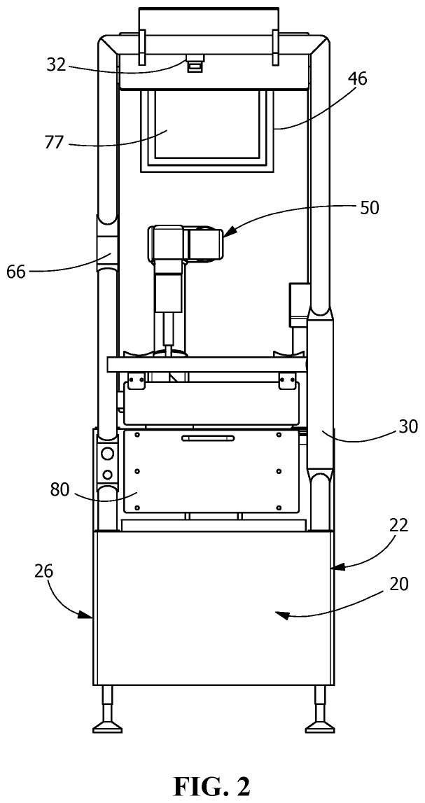

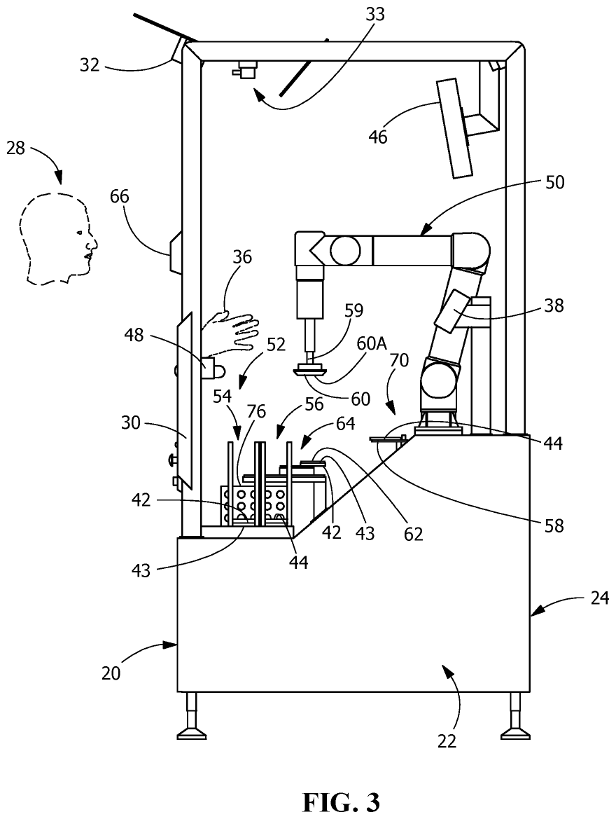

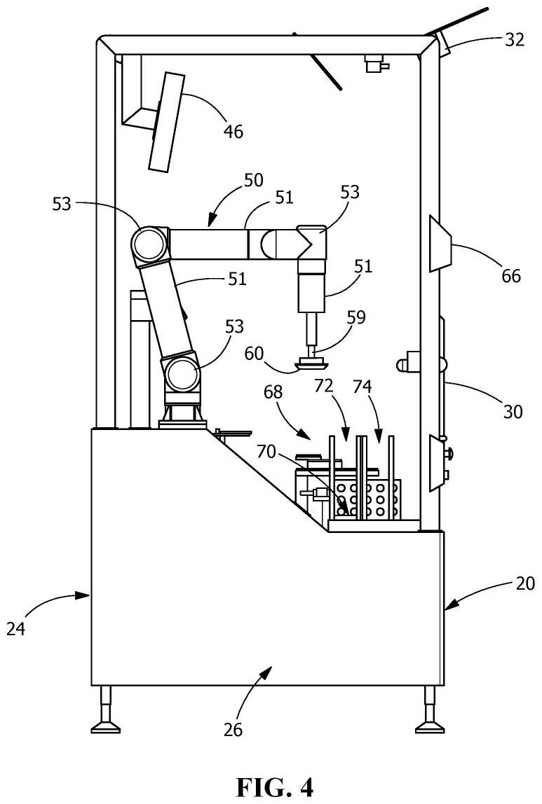

Referring to FIGS. 1-4, a sampling system 10 includes a structure 12 including an open upper portion 14 and a lower portion 16. The open upper portion 14 can be formed from a plurality of interconnected support members 18 made from various materials, such as, for example, metal, plastic, or a combination of materials. As shown, structure 12 supports components, such as sensors 30, 32, cameras 33, 38, 66, a first partially enclosed storage region 52 (FIG. 3) for holding several fresh growth medium containers 42 adapted for cell culturing, sometimes referred to, as Petri dishes/plates or agar dishes/plates, as well as several transparent lids 44 used for covering the growth medium containers 42 after a sample is collected, a touchless interface 46, a second partially enclosed storage 68 (FIG. 4) for securing sampled and covered growth medium containers 70, and a robotic arm 50 that will be discussed in further detail below.

In some implementations, the structure 12 includes a door 80 to access the interior of the structure 12. By way example, the door 80 can be located on a lower portion of the structure 12 to access the storage region 52 and handle the fresh growth medium containers 42.

As shown, structure 12 includes sides 20, 22, 24, 26, with one side (i.e., side 20) configured to receive an interactive living entity 28 from which the sample is to be taken. In one implementation, when viewed from a front view, side 20 is embodied as a front side, side 24 is embodied as a back side, side 22 is embodied as a right side, and side 26 is embodied as a left side. By way of example, structure 12 can be substantially rectangular in shape. In some implementations, as shown in FIG. 1, the interactive living entity 28, such as a human, is positioned in close proximity to side 20 or a predetermined position relative to structure 12. In one embodiment, in response to human 28 being positioned in close proximity to side 20 for a predetermined time, sensor 30, such as, for example, a UHF sensor or an RFID sensor senses an RFID (not shown) which is uniquely associated with human 28 for specifically identifying human 28. It should be appreciated that other sensors besides ones mentioned herein may be employed to detect the presence of human 28. In one implementation, as shown in FIG. 1, sensor 30 can be located at side 20 on one support member 18 extending in a vertical direction and sensor 32 can be located at side 20 on one support member 18 extending in a horizontal direction. As a result, this ensures that sensors 30, 32 capture (or sense) the presence of human 28 on side 20 of the structure 12.

As further shown in FIG. 1, after human 28 has been positioned in close proximity to side 20 for a predetermined time, one or more cameras 33, 66 is adapted to recognize, by itself by comparing images with information in a look-up table such as with software utilizing Artificial Intelligence and computer vision, an indicia 34 such as a hand 36 of human 28. By way of example, the indicia 34 can be formed in a distinctive position or gesture, such as, for example an “OK” sign, or “thumbs up” or other distinctive arrangement that could be formed by the human's hand.

In some implementations, the cameras 33, 38, 66 are monochrome industrial cameras, a color camera with the capacity to assess depth, and combinations thereof, all of which can individually and in combination provide input to the system to the position of the hand 36 with respect to the robotic 50 and other components within an envelope of structure 12.

In other implementations, the indicia 34 may be a symbol such as, for example, formed on a portion of the human's uniform that may require the human to slightly pivot or otherwise move the portion of the human's uniform into unobstructed view of the camera 66. In other implementations, the indicia 34 may be distinctive sounds uttered by human 28 (or animal) that is audibly sensed by another sensor, such as a microphone (not shown), or a combination thereof.

It will be appreciated by those having ordinary skill in the art that the human 28 in the clean room environment will be wearing gloves and that the gloves may be of different colors. Exemplary embodiments are able to discern the presence of the hand 36 regardless of the color of the glove, even in instances in which the vision system of the touchless interface 46 is keyed to recognize skin colors by first converting the glove color to that of a recognized skin tone.

When human 28 has been sensed by sensor 30 as a result of being in close proximity of side 20, as well as cameras 33, 66 (or other sensor(s)) recognizing indicia 34, a controller 40 initiates an operating cycle, or continues the previously initiated operating cycle, for taking a sample from human 28. In some implementations, the controller 40 is located in the bottom portion 16 of structure 12. By way of example, the controller 40 is integrally assembled in the bottom portion 16 of structure 12. In other implementations, the controller 40 can be located remotely from the structure 12.

Once controller 40 initiates the operating cycle for taking a sample from human 28, the touchless interface 46, such as a visual monitor or display, is in operation for interaction by human 28. For example, the touchless interface 46 is illuminated (or displayed) to show human 28 where to place his/her hands 36 in preparation for collecting the sample. In one implementation, a rest 48 is provided on the structure 12 to stably support a corresponding wrist or forearm of each hand 36, i.e., provide support such that the hand and associated fingers can be sufficiently non-movingly positioned so that sample(s) of the fingers may be taken. In one implementation, camera 33, located near the rest 48, is employed for displaying an image of a portion of the hand on the touchless interface 46 and assist the human 28 for placement of the hand on the touchless interface 46. This ensures the hand of human 28 is detected and that proper placement is achieved.

The robotic arm 50, such as an anthropomorphic arm having a plurality of arm portions 51, is mounted to structure 12. In one implementation, the robotic arm 50 is mounted on a top surface portion 15 (FIG. 1) of the bottom portion 16 of structure 12. Each arm portion 51 includes a plurality of rotatable joints 53 to provide a plurality of degrees of freedom. Further, each arm portion 51 can be independently moved with respect to each other. The robotic arm 50 is configured to operate and manipulate (i.e., control) the fresh growth medium containers 42, the transparent lids 44, as well as the sampled and covered growth medium containers 70 (FIG. 4). More specifically, as shown in an example embodiment of FIG. 3, an end effector 59 of robotic arm 50 accesses and holds a fresh unexposed enclosed growth medium container 42 from the storage 52 (or storage area or repository) including a storage portion 54 for securing fresh unexposed enclosed growth medium containers 42, a storage portion 56 for securing transparent lids 44, and storage portions 72, 74 (FIG. 4) for securing sampled and covered growth medium containers 70 (FIG. 4) that have collected sample(s) from human 28, such as from hands 36 or other predetermined portion of the human, such as the sleeves.

During an operating cycle of the sampling system, once hands 36 are positioned as communicated to human 28 by the touchless interface 46, which positioning is confirmed as sensed by one or more sensors/cameras, such as sufficiently spreading or otherwise positioning the individual digits of hands 36 so that sampling may be achieved, the robotic arm 50 can be activated. That is, the end effector 59 of robotic arm 50 extends into storage portion 56 and removes the transparent lid 44, and places the transparent lid 44 on a horizontal generally planar platform 58 for holding the transparent lid 44. In one implementation, the platform 58 can include a friction surface to hold the transparent lid 44 in position on platform 58 when the robotic arm 50 directs the transparent lid 44 into sufficient pressurized contact with the friction surface of platform 58, as shown in FIGS. 1 and 3.

Next, the end effector 59 of robotic arm 50 extends into the storage portion 54 and removes an unexposed enclosed agar dish/plate 42 to which is initially secured a temporary cover 43 and places the unexposed enclosed agar dish/plate 42 and a corresponding cover 44 on a horizontal generally planar platform 64 for disassembling/separating the unexposed enclosed agar dish/plate 42 from the cover 43. In one implementation, the platform 64 can include a friction surface and/or appropriate tool (not shown) to permit the robotic arm 50 to disassemble the unexposed enclosed agar dish/plate 42 (i.e., separating cover 43 from an exposed growth medium 62 of the unexposed enclosed agar dish/plate 42). For example, the robotic arm 50 grips and applies a rotational movement and/or a separation force to cover 43 relative to unexposed enclosed agar dish/plate 42 in frictional contact with platform 68, resulting in separation of cover 43 from exposed growth medium 62 of the unexposed enclosed agar dish/plate 42. In some implementations, the cover 43 can be directed into a waste storage container 76 (as shown in FIG. 3).

Subsequent to disassembly of the unexposed enclosed agar dish/plate 42 and cover 43, the end effector 59 of robotic arm 50 directs the unexposed enclosed agar dish/plate 42 (i.e., the now uncovered unexposed container or agar dish/plate 60) and manipulates the uncovered unexposed agar dish/plate 60 into sufficient contact with the fingers/sleeves or other regions of human 28 for collecting the sample(s). The robotic arm 50 is preferably a force sensitive robotic arm to avoid harming the human 28 during the manipulations steps, which is accomplished in combination with the cameras 32 and other sensors identifying the position of the hand 36 within the envelope of the structure 12. The speed at which the robotic arm 50 is manipulated and/or translated within the envelope is controlled to avoid causing disturbances that would initiate particulate movement about predetermined levels for the specific class of clean room in which the system 10 is being used.

In some implementations, the robotic arm 50 may begin accessing unexposed enclosed agar dish/plate 42 prior to final positioning of hands 36 in order to reduce the total sampling cycle time, with safety features in place to prevent inadvertent injury to the human 28.

In some implementations, more than one sample (i.e., more than one agar dish/plate 42) may need to be collected from a single human 28. Once an uncovered unexposed agar dish/plate 60 has collected a sample or otherwise completed a predetermined sampling of human 28 (becoming uncovered exposed or uncovered sampled agar dish/plate 60A), the robotic arm 50 returns the uncovered exposed agar dish/plate 60A to its corresponding lid 44 supported by platform 58 and assembles the lid 44 and the uncovered exposed agar dish/plate 60A (e.g., such as by reversing the disassembly process previously discussed between agar dish/plate 42 and cover 43) resulting in the formation of an exposed enclosed or sampled and covered agar dish/plate or container 70.

In one implementation, assembling includes locking the corresponding lid 44 and corresponding uncovered exposed agar dish/plate 60A together and/or installing a tampering evident seal thereon. In some implementations, the position of the platform 58 and/or the lid 44 on the platform is identified by features such as grooves or ridges on the lid 44 detected by the cameras 33 or other sensors in directing the robotic arm 50 to the appropriate location of the structure 12. Once the sampled and covered agar dish/plate 70 has been assembled, robotic arm 50 temporarily moves away to permit camera 38 (FIG. 1) to record a photographic image of information contained on a label secured to the exposed surface of the sampled and covered agar dish/plate 70 that is saved, for example, by a storage device associated with the system 10. The information uniquely identifies each sampled and covered agar dish/plate 70.

Additionally, the robotic arm 50 then moves away from the sampled and covered agar dish/plate 70 to platform 58 for placing unique identification information, such as the identity of the human, the location where the sample was taken, the time the sample was taken, etc., physically on the sampled and covered agar dish/plate 70 or updating an RFID secured to the sampled and covered agar dish/plate 70, printing and affixing a label, or other suitable method or technique for identification. In one implementation, a database is updated to include the identification information, which may then be further updated to include pick-up and testing information when performed. Once identified, the robotic arm 50 places the sampled and covered agar dish/plate 70 in storage portion 70 or 72 for subsequent collection and testing.

Once the sample is taken, and after human 28 has confirmed all required identification information associated with documenting the particulars associated with the sampling, including the identity of the human, including documenting any anomalies/clarifications/corrections that may be required by recording such anomalies/clarifications/corrections on a form adjacent the system that may also saving an image of the form once completed by human 28, touchless interface 46 communicates to human 28 that he/she may leave, which may occur prior to any of the assembly, identification and movement to storage operations steps associated with the sampling cycle previously discussed. In some implementations, the touchless interface 46 may at least partially, if not totally include emission of sounds such as verbal instructions to communicate with the test subject.

Once the sampling cycle has been completed, preferably the sampling system 10 returns to a power saving mode, awaiting the next testing subject, at which time the previously discussed operating cycle is repeated.

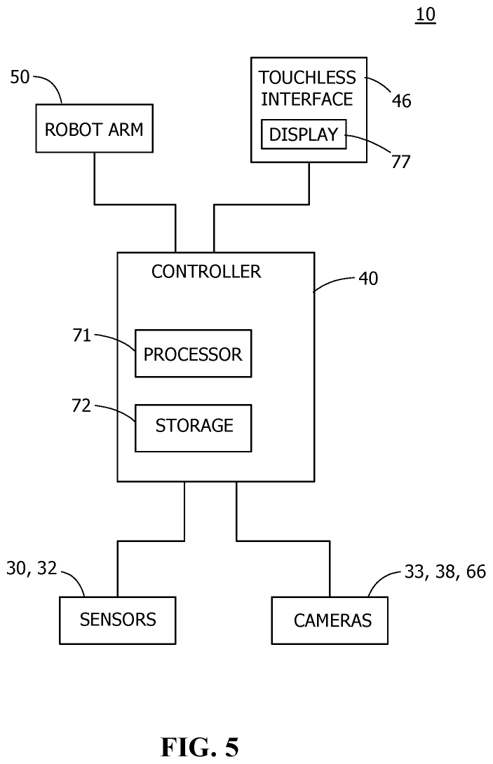

Referring now to FIG. 5, which is a schematic representation of a sampling system 10, according to an example embodiment of the present disclosure. The sampling system 10 includes a controller 40 in communication with sensor 30, 32, cameras 33, 38, 66, the touchless interface 46, and the robotic arm 50. In some implementations, the controller 40 may be hardwired to the sensor 30, 32, the cameras 33, 38, 66, the touchless interface 46, and/or the robotic arm 50 for communication. In other implementations, the controller 40 may communicate by any wireless communication protocols or means, such as Bluetooth, Wi-Fi, RF transmission, GPS, or the like. The controller 40 may perform data processing and communicate information to a storage system. The storage system may be implemented as a single storage device, but may also be implemented across multiple storage devices or subsystems located at disparate locations and communicatively connected, such as in a cloud computing system.

The controller 40 includes a processor 71 and a storage system 72. The storage system 72 includes software, including stored data 59, including data in database structure, i.e., a look-up table. The processor 71 loads and executes software stored in the storage system 72. The processor 71 can also access data stored in the database in order to carry out the methods and control instructions described herein. Although the controller 40 is depicted in FIG. 5 as one, unitary system encapsulating one processor 71 and one storage system 72, it should be appreciated that one or more storage systems 72 and one or more processors 71, may comprise the controller 40, which may be a cloud computing application and system. The processor 71 includes a processor, which may be a microprocessor, a general purpose central processing unit, an application-specific processor, a microcontroller, or any type of logic device. The processor 71 may also include circuitry for retrieving and executing software from the storage system 72. The processor 71 may be implemented with a single processing device, but may also be distributed across multiple processing devices or subsystems that cooperate in executing software instructions.

The storage system 72, which stores database, i.e., look-up table, may comprise any storage media, or group of storage media, readable by processor 71, and capable of storing software and data. The storage system 72 can include volatile and non-volatile, removable and non-removable media implemented in any method or technology for storage of information, such as computer-readable instructions, data structures, program modules, or other data. As described above, storage system 72 may be implemented as a single storage device, but may also be implemented across multiple storage devices or subsystems located at disparate locations and communicatively connected, such as in a cloud computing system. Examples of storage media include random access memory, read only memory, optical discs, flash memory, virtual memory, and non-virtual memory, or any other medium which can be used to store the desired information and may be accessed by the processor 71.

The controller 40 provides control instructions to be executed by the sensors 30, 32. In one implementation, the control instructions may receive instructions that an interactive entity, such as a human, is positioned in close proximity to side (i.e., 20) or a predetermined position relative to structure 12. This enables the controller 40 to identify that is uniquely associated with human 28 for specifically identifying the human 28.

The controller 40 further provides control instructions to be executed by the cameras 33, 38, 66. In one implementation, the control instructions may receive instructions to recognize, by comparing images captured by cameras 33 or 66 with information in a look-up table (or in combination with the sensors 30, 32) such as with software utilizing Artificial Intelligence and computer vision, an indicia 34 such as a distinctive position or gesture of the hand, e.g., “OK” sign, or “thumbs up” captured by the cameras 33 or 66. In other implementations, the controller 40 provides control instructions to be executed by camera 38 in conjunction with the touchless interface 46. For example, the controller 40 executes instructions for taking a sample from human 28 and provides instructions to operate the touchless interface 46, via a display 77, to display where to place the hands 36 of human 28 in preparation for collecting the sample.

The controller 40 further provides control instructions to be executed by the robotic arm 50. In one implementation, the control instructions may receive instructions to operate the robotic arm 50 to hold and transport the containers 42, the transparent lids 44 as well as the sampled and covered growth medium containers 70. For example, the robot arm 50 removes and places the lids, removes the agar dishes/plates from the holding container, uncaps the agar dishes/plates and effectively rolls the agar dish/plate across human 28, e.g., each fingertip of the left and right hand and sleeves to collect samples. The robot arm 50 then places and locks the sampled agar dishes/plates onto the lids, followed by placing of locked plates into the collection container. The controller 40 identifies and allocate each agar dish/plate to the unique personnel and sample location.

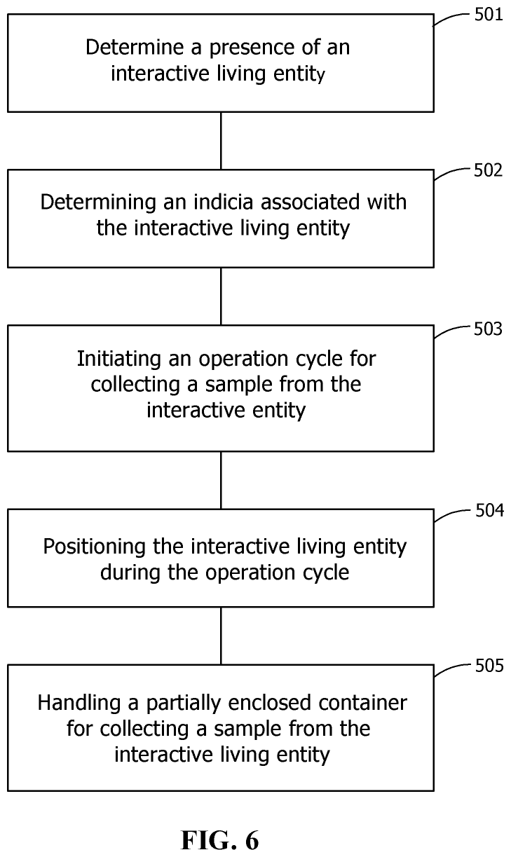

Referring now to FIG. 6, a flowchart of a method for automatically collecting a sample from an interactive living entity in a clean room is illustrated, in accordance with an example embodiment. At step 501, the controller determines a presence of the interactive living entity. In one implementation, the controller determines the presence when the interactive living entity is at a predetermined position relative to the structure for a predetermined time. At step 502, the controller determines an indicia associated with the interactive living entity. In one implementation, the indicia can be a hand gesture. In other implementations, the indicia can be a symbol formed on a portion of a uniform worn by the interactive living entity. In other implementations, the indicia can be a distinctive sound communicated by the interactive living entity. At step 503, the controller initiates an operating cycle, or continuation of the previously initiated operating cycle, for collecting a sample from the interactive living entity, based on the determined presence of the interactive living entity (step 501) and the determined indicia (step 502). Next, in step 504, the controller sends instructions to position the interactive living entity during the operating cycle. In one implementation, the controller operates a touchless interface to provide positioning instructions to the interactive living entity. For example, the touchless interface can be a visual monitor where the visual monitor can include a display that displays a placement location for a hand of the interactive living entity to be placed in the structure for collecting the sample. To describe in a different manner, the visual monitor is illuminated for the hands of the interactive living entity to be placed in a proper position in the structure. Then at step 505, the controller sends instructions to the robot arm to handling a partially enclosed container for collecting the sample in the partially enclosed container from the interactive living entity. In some implementations, the handling of the partially enclosed container includes collecting the sample from the interactive living entity by moving the partially enclosed container across each fingertip of a hand of the interactive living entity. In other implementations, the robotic arm is configured to collect the sample from the interactive living entity by moving the partially enclosed container across a sleeve of the interactive living entity. In other implementations, the robot arm is configured to access and hold the partially enclosed container from a storage area of the structure, including extending into the storage area and removing a lid and placing the lid on a planar platform to hold the lid thereon.

As illustrated herein, various example embodiments provide systems and methods for collecting a sample from an interactive living entity in a clean room. The system performs automated collection of sample in a sterile environment without any contamination. This enables a touchless hand pose human machine interface, automated lid and agar dish/plate handling, collaborative robotic sampling of personnel, automatic sample attribution and database reporting. As a result, this eliminates the need for human-to-human contact, saves time and labor costs, reduces personnel downtime, inconsistent sampling as well as overall process related inefficiencies.

For purposes herein, the term “sample” and “samples” may be used interchangeably, as one skilled in the art can appreciate that the same agar dish/plate may contact multiple different areas, or multiple agar dishes/plates may each be used to contact a single area, as appropriate.

For purposes herein, the term “interactive living entity” or “test subject” is intended to include a human or animal, such as a trained animal that is capable of forming a symbol or communicating, such as by providing indicia such as visual indicia that is sensed or recognized by sensors for the purpose of initiating an operating cycle, or continuing the previously initiated operating cycle of the sampling system.

For purposes herein, the term “interactive entity” is intended to include a non-living entity that is monitored/controlled by a human (e.g., remote controlled device, such as a robot or drone) in which the monitoring/controlling human can communicate (e.g., remotely communicate) with the system for collecting a sample from the non-living entity by the system.

For purposes herein, the term “independent interactive entity” is intended to include a non-living entity, such as a robot or device that has been preprogrammed to specifically respond to commands from the system or incorporates Artificial Intelligence that permits the non-living entity to communicate/interact with the system for collecting a sample from the non-living entity by the system in a manner similar to collecting a sample from an interactive living entity without requiring human control.

It is appreciated that the sampling system including the touchless interface is not limited to clean rooms and contemplates applications for automated touchless processing involving humans and animals for any number of applications, such as taking fingerprints, medical screenings, admissions to events/travel, etc.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is to be understood that the various descriptions of the embodiments disclosed herein have been simplified to illustrate only those elements, features, and aspects that are relevant to a clear understanding of the disclosed embodiments, while eliminating, for purposes of clarity, other elements, features, and aspects. Persons having ordinary skill in the art, upon considering the present description of the disclosed embodiments, will recognize that other elements and/or features may be desirable in a particular implementation or application of the disclosed embodiments. However, because such other elements and/or features may be readily ascertained and implemented by persons having ordinary skill in the art upon considering the present description of the disclosed embodiments, and are therefore not necessary for a complete understanding of the disclosed embodiments, a description of such elements and/or features is not provided herein. As such, it is to be understood that the description set forth herein is merely exemplary and illustrative of the disclosed embodiments and is not intended to limit the scope of the invention as defined solely by the claims.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. An interactive living entity sampling system, comprising:
a structure supporting components including a first sensor, a second sensor, a robotic arm, a camera, and a touchless interface, wherein the structure and the components are adapted for use in a clean room,
wherein the first sensor is adapted to sense the interactive living entity in response to the interactive living entity being at a predetermined position relative to the structure for a predetermined time,
wherein the second sensor is adapted to sense an indicia associated with the interactive living entity; wherein in response to the second sensor sensing the indicia, the sampling system initiates an operating cycle, or continues the previously initiated operating cycle, for collecting a sample from the interactive living entity, and
wherein during the operating cycle, the touchless interface provides positioning instructions to the interactive living entity in combination with the robotic arm handling a partially enclosed container for collecting the sample from the interactive living entity.

2. The sampling system of claim 1, wherein the indicia is a hand gesture.

3. The sampling system of claim 1, wherein the indicia is a symbol formed on a portion of a uniform worn by the interactive living entity.

4. The sampling system of claim 1, wherein the indicia is a distinctive sound communicated by the interactive living entity.

5. The sampling system of claim 1, wherein the touchless interface is a visual monitor, wherein the visual monitor includes a display that displays a placement location for a hand of the interactive living entity to be placed in the structure for collecting the sample.

6. The sampling system of claim 5, further comprising a rest portion provided on the structure to stably support the hand of the interactive living entity for collection of the sample.

7. The sampling system of claim 1, wherein the robot arm includes an end effector to access and hold the partially enclosed container from a storage area of the structure, wherein the partially enclosed container is manipulated by the robot arm to collect the sample from the interactive living entity.

8. The sampling system of claim 7, wherein the end effector of the robot arm extends into the storage area and removes a lid and places the lid on a planar platform to hold the lid thereon.

9. The sampling system of claim 7, wherein the planar platform includes a friction surface to hold the lid in position on the planar platform.

10. The sampling system of claim 1, wherein the robotic arm is configured to place an identification information on the partially enclosed container associated with at least one of an identity of the interactive living entity, a location where the sample was taken, or a time the sample was taken.

11. The sampling system of claim 1, wherein the robotic arm is configured to collect the sample from the interactive living entity by moving the partially enclosed container across each fingertip of the hand of the interactive living entity.

12. The sampling system of claim 1, wherein the robotic arm is configured to collect the sample from the interactive living entity by moving the partially enclosed container across a sleeve of the interactive living entity.

13. An automatic personnel sampling system, comprising:
a structure having a top portion and a bottom portion, the top portion including:
a first sensor configured to sense a presence of an interactive living entity;
a second sensor configured to sense an indicia associated with the interactive living entity;
a touchless interface configured to position the interactive living entity for collecting a sample from the interactive living entity; and
a robot arm configured to handle an at least partially enclosed container that holds a growth medium adapted for cell culturing,
wherein the robot arm, in conjunction with the touchless interface, collects the sample from the interactive living entity by moving the partially enclosed container across each fingertip of a hand of the interactive living entity.

14. The sampling system of claim 13, wherein the indicia is a hand gesture.

15. The sampling system of claim 13, wherein the touchless interface is a visual display, wherein the visual display displays a placement location for the hand of the interactive living entity to be placed for proper placement.

16. The sampling system of claim 13, further comprising a camera, wherein the camera captures an image of information contained on a label secured to the at least partially enclosed container for identifying the sample and the interactive living entity.

17. A method for automatically collecting a sample from an interactive living entity in a clean room, the method comprising:
providing a structure supporting components including a first sensor, a second sensor, a robotic arm, a camera, and a touchless interface;
determining a presence of the interactive living entity when the interactive living entity is at a predetermined position relative to the structure for a predetermined time;
determining an indicia associated with the interactive living entity;
based on the determined presence of the interactive living entity and the determined indicia, initiating an operating cycle, or continuation of the previously initiated operating cycle, for collecting a sample from the interactive living entity;
positioning the interactive living entity during the operating cycle; and
handling a partially enclosed container, via the robotic arm, for collecting the sample in the partially enclosed container from the interactive living entity.

18. The method of claim 17, wherein the indicia is a hand gesture.

19. The method of claim 17, wherein positioning the interactive living entity includes positioning a hand of the interactive living entity to be placed in a location in the structure for collecting the sample.

20. The method of claim 17, wherein handling the partially enclosed container includes collecting the sample from the interactive living entity by moving the partially enclosed container across each fingertip of a hand of the interactive living entity.
